(19) United States
(12) Patent Application Publication
(10) Pub. No.: US 2017/0274696 A1
(43) Pub. Date: Sep. 28, 2017

(54) ECO-FRIENDLY CARD CONSTRUCTION AND METHOD

(71) Applicant: HAZEN PAPER COMPANY, HOLYOKE, MA (US)

(72) Inventors: John Hazen, South Hadley, MA (US); Larry Hoague, Feedings Hills, MA (US)

(73) Assignee: HAZEN PAPER COMPANY, HOLYOKE, MA (US)

(21) Appl. No.: 15/622,192

(22) Filed: Jun. 14, 2017

Related U.S. Application Data
(63) Continuation-in-part of application No. 13/901,733, filed on May 24, 2013.

(51) Int. Cl. B42D 25/47; B42D 25/369; B42D 25/23; B42D 25/455; B32B 37/20; B42D 25/475; B42D 25/20; B32B 7/12; B32B 29/00; B42D 25/328; B42D 25/46

(52) U.S. Cl. CPC B42D 25/47; B42D 25/328; B42D 25/369; B42D 25/23; B42D 25/455; B42D 25/46; B42D 25/475; B42D 25/285; B32B 7/12; B32B 29/005; B32B 37/20; B32B 2317/12; B32B 2255/12; B32B 2425/00

(57) ABSTRACT

A manufacturing assembly for the creation of laminate constructions includes a calendar device arranged to accept a laminate of three or more layers of material stock, as provided by a matching three or more rolls of the material stock. A sheeting device is arranged downstream from the calendar device for cutting the laminate into predetermined sizes, such that the laminate is kept in a non-rolled, planar orientation subsequent to the laminate exiting the calendar and before the laminate is sheeted by the sheeting device.

### CROSS REFERENCE TO RELATED APPLICATIONS

This application is a continuation-in-part of U.S. Utility patent application Ser. No. 13/901,733 filed on May 24, 2013 and claims the benefit of U.S. Provisional Application No. 61/660,218, filed Jun. 15, 2012, each of which are hereby incorporated by reference in their entireties.

### FIELD OF THE INVENTION

The present invention relates generally to cards, such as transaction, information, identification and stored value cards and, more particularly, to a recyclable and repulpable stored value card and related method for making the same.

### BACKGROUND OF THE INVENTION

Plastic cards are used frequently in everyday commerce and are becoming more prevalent in a variety of applications. Plastic cards can include transaction, information, identification, and/or stored value cards, such as, for example, gift cards, debit cards, credit cards, phone cards, identification cards, driver licenses, etc. These plastic cards can include printed indica, such as a card number, identification information, expiration date, financial institution, store information, and the like, as well as artwork and other visual imagery. In addition, plastic cards, such as financial transaction cards, can include a magnetic strip that is adhered to or embossed on the card, often on the back of the card. The magnetic strip is encoded with the card information and/or account information and is configured to be read by a card reader.

As the number of cards being produced increases, the amount of scrap material resulting from processing plastic cards and from discarded plastic cards themselves continues to increase. Plastic cards are typically manufactured using a polymeric material such as polyvinyl chloride (PVC) or styrene. These materials provide the desired properties and characteristics of the plastic cards, such as, for example, rigidity, machinability, durability, appearance and feel.

Materials such as PVC and styrene, however, also have numerous negative qualities. For example, these materials are perceived as being environmentally unfriendly in that they do not biodegrade readily and have no established recycling stream. PVC, for example, raises environmental concerns with the use of vinyl chloride, phthalate plasticizers, and dioxin when such material is burned. In addition, PVC and polystyrene are made from either crude oil or natural gas, and can therefore be subject to oil price fluctuations. Moreover, certain countries and regions such as the European Union have enacted stricter waste stream regulations, which limit the use of materials that may be deemed not environmentally friendly. Even plastics that are more environmentally friendly are not without at least some of these drawbacks.

As such, there is a need for a card, such as a stored value, transaction, identification card, etc., that retains the benefits of machinability, durability, appearance and feel of existing plastic cards without the environmental drawbacks typically associated with such plastic cards.

### SUMMARY OF THE INVENTION

It is an object of the present invention to provide a card such as a transaction, information, identification, and/or stored value card.

It is an additional object of the present invention to provide a paper card that has the appearance, feel, rigidity and machinability of existing plastic cards.

It is another object of the present invention to provide a paper card having a hologram.

It is another object of the present invention to provide a paper card that is recyclable and repulpable.

It is another object of the present invention to provide a paper card that complies with “green” or environmentally friendly waste stream regulations.

It is another object of the present invention to provide a method for manufacturing a card such as a transaction, information, identification, and/or stored value card having the machinability, appearance and feel of a plastic card.

It is another object of the present invention to provide a method for manufacturing a card that is recyclable and repulpable.

It is another object of the present invention to provide an apparatus and method for the manufacture of a multi-layered paper card that avoids the inducement of stress fractures and material degradation.

An embodiment of the inventive eco-friendly card construction includes laminating three or more piles of paper stock in a single lamination process, whereby the three or more plies of paper stock are adhered to one another via an adhesive between each of the plies of paper stock. No PVC or other plastic material is utilized in the construction of the eco-card of the present invention. After the three or more piles of paper stock have been laminated to one another, a calendar device may be utilized to ensure that the eco-card has a Sheffield smoothness of 30 or less and a thickness in the range of 27-30 mils. Moreover, in a preferred embodiment of the present invention, the finished eco-card construction is sheeted in-line, thereby avoiding the need to roll up the laminate construction. The deposition of recyclable ink or metallic layers or holograms may also be conducted in-line, preferably at a point prior to the eco-card being sheeted.

These and other objects, features and advantages of the present invention will become apparent in light of the detailed description of the best mode embodiment thereof, as illustrated in the accompanying drawings.

### BRIEF DESCRIPTION OF THE DRAWINGS

FIG. 1 is a top plan view of an eco-friendly card, in accordance with an embodiment of the present invention.

FIG. 2 is a detail, side elevational view of the eco-friendly card of FIG. 1, showing the construction thereof.

FIG. 3 is a flowchart illustrating a method for producing an eco-friendly card, in accordance with an embodiment of the present invention.

FIG. 4 is a schematic diagram of an eco-card, multi-pile lamination apparatus, in accordance with one embodiment of the present invention.

### DETAILED DESCRIPTION OF THE PREFERRED EMBODIMENT

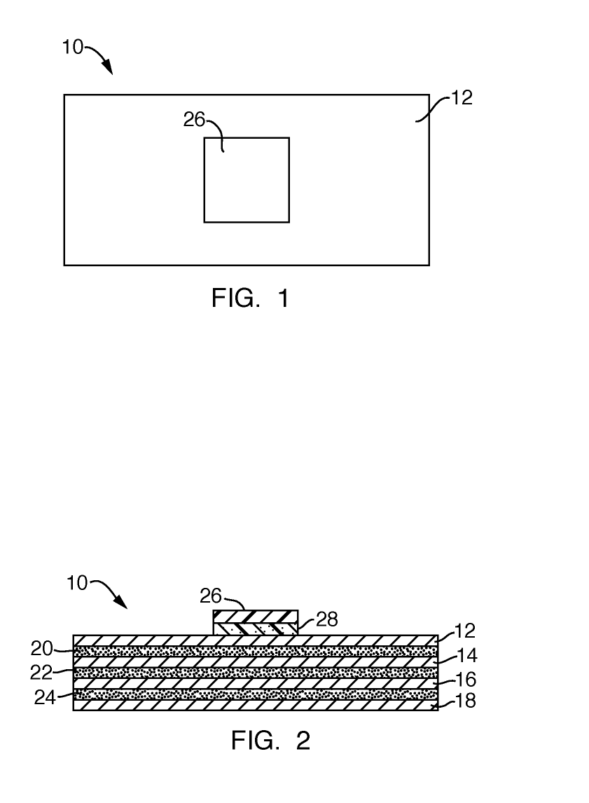

Referring to FIGS. 1 and 2, an eco-friendly card construction 10 according to the present invention is shown. The card 10 includes a plurality of plies of paper stock that are held together with an adhesive between each ply. The paper stock may be one of numerous types of paper stock known in the art, but in any event the paper stock is recyclable and repulpable. In the preferred embodiment, there are four plies 12, 14, 16, 18 of paper stock that are bound together with adhesive layers 20, 22, 24 there between. In particular, as shown in FIG. 2, ply 12 is bound to ply 14 by adhesive layer 20, ply 14 is bound to ply 16 by adhesive layer 22 and ply 16 is bound to ply 18 by adhesive layer 24. As further shown therein, a holographic lamination 26 containing a hologram is bound to the top ply 14 by a holographic lamination adhesive layer 28.

In the preferred embodiment, the card 10 has a Sheffield smoothness of 30 or lower and a caliper in the range of 27-30 mils, and more preferably 30 mils. Importantly, it has been discovered that a four-ply paper stock card having these smoothness and thickness ranges has the appearance, feel, rigidity and machinability of existing plastic cards. As will be readily appreciated, the machinability of the card is important, as a press-ready sheet of material from which the cards are machined is often shipped to downstream printing companies who print text or images on the sheet and cut the cards from the press-ready sheet. Moreover, the appearance and feel of the card is important to consumers who have become used to the look and feel of plastic cards, and who may perceive rough, thin and malleable cards as cheap. In addition, the durability of the card 10 resulting from the four ply construction and the specific thickness and smoothness values noted above is crucial, especially for cards such as debit, credit or gift cards that may be run through a card reader numerous times throughout their life.

As noted above, the particular construction of the card 10 gives the card the machinability, appearance and feel of existing plastic cards, which have a certain appeal because of these features. In addition, in contrast to existing plastic cards, however, the card 10 of the present invention is environmentally friendly in that it is both recyclable and repulpable. Accordingly, the card 10 may be recycled and remade into other cards or other paper products, and does not contribute to environmental degradation like existing plastic cards do.

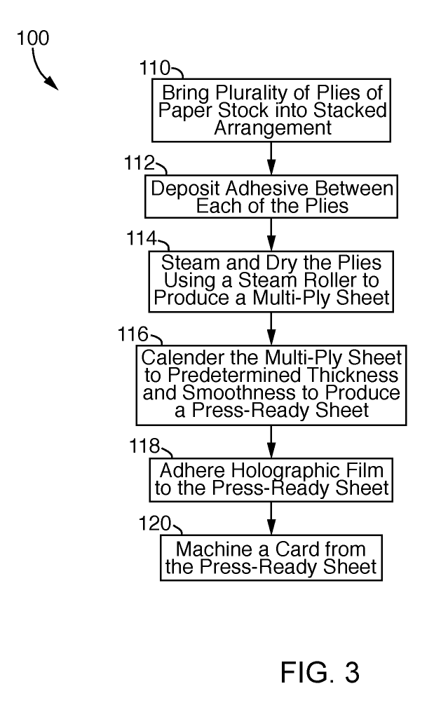

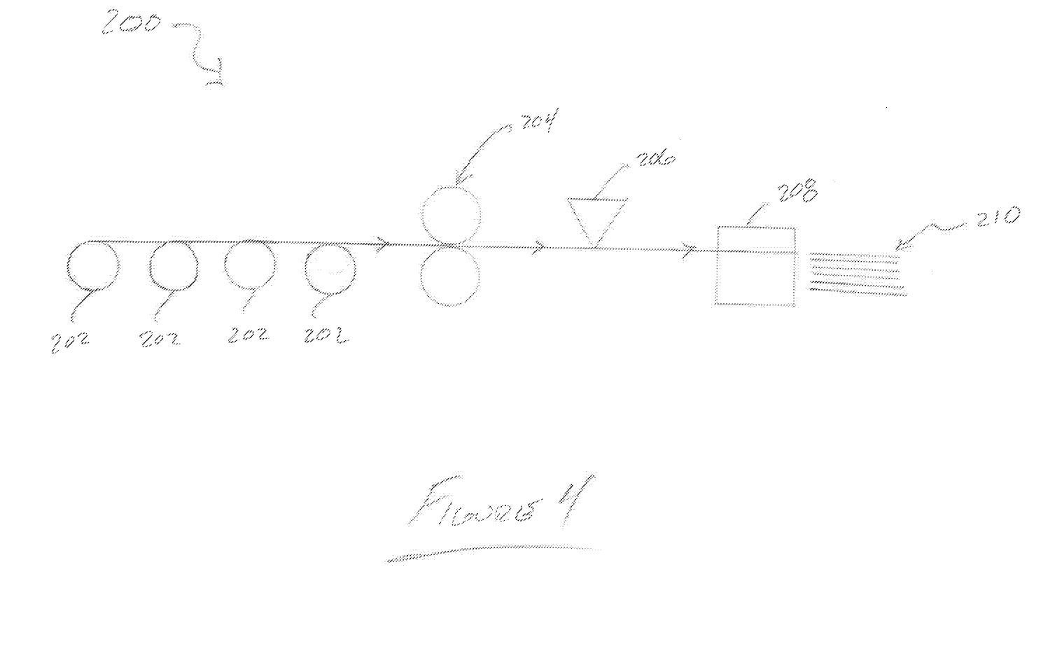

With reference to FIG. 3 a method 100 for manufacturing an eco-friendly card is illustrated. As shown therein, at step 110, the four plies of paper stock 12, 14, 16, 18 are simultaneously unwound from rolls and brought into stacking alignment with one another. Adhesive is then applied between the plies in a manner known in the art, at step 112, in order to bond the plies 12, 14, 16, 18 together. At step 114, the adhered plies are steamed and dried utilizing steamrollers. Finally, the dried plies are calendared, at step 116, by passing the plies through an array of calendar rollers in order to precisely control thickness and smoothness of the resulting press-ready sheet.

After passing through the calendar rollers, the press-ready sheet can be examined to ensure that the specifications of the sheet fall within preferred parameter ranges. In particular, the sheet may be examined to determine internal moisture, thickness and smoothness, which directly result in giving the press-ready sheet the look, feel and durability of a plastic card. In the event that any one or more of the internal moisture, thickness and smoothness is not within ideal ranges, the calendar rollers and other components of the apparatus can be adjusted until the resultant press-ready sheet falls within the preferred parameter ranges.

After the press-ready sheet having the look, feel, rigidity and durability of a plastic card is produced, it can be cut and shipped directly to downstream processing companies for printing, inlaying of a magnetic strip, etc. Alternatively, however, a hologram may be laminated to the surface of the sheet at predetermined locations. In particular, at step 118, a holographic film 26 containing a hologram is bound to the top ply of the press-ready sheet by a holographic lamination adhesive layer 28. In an embodiment, the hologram is a transfer layer of metal that is bound to the top ply of the sheet using a transfer film, as is known in the art. In any event, the press-ready sheet with or without the hologram can be cut into cards, at step 120, or can be shipped to customers or down stream processors for ink printing, cutting to shape, etc.

In an embodiment, a transfer layer of metal may be adhered to the press-ready sheet utilizing any technology or method known in the art. After the transfer layer of metal is adhered to the press-ready sheet, repeating or different holographic images may be imaged/printed on the sheet at predetermined locations utilizing methods known in the art. As will be readily appreciated, as discussed above, it is important that the holographic images be precisely located on the press-ready sheet so that these images may be centered or otherwise properly positioned on the finished and cut eco-friendly card.

Importantly, the eco-friendly card 10 of the present invention is intended to replace existing plastic cards that are environmentally unfriendly. In particular, the card 10 of the present invention may be a transaction, information, identification, and/or stored value card, such as, for example, gift cards, debit cards, credit cards, phone cards, identification cards, driver licenses, etc.

As discussed in connection with the method illustrated in FIG. 3, the present invention utilizes a manufacturing apparatus that is capable of laminating three or more sheets of paper stock, in a single lamination run.

In particular, FIG. 4 illustrates a schematic diagram of an eco-card, multi-pile lamination apparatus, in accordance with one embodiment of the present invention. As shown in FIG. 4, the eco-card lamination apparatus 200 includes three or more rolls of substrate, typically paper stock, 202. The rolls 202 may be arranged in any manner provided that they are capable of feeding their respective paper stocks so as to lay each paper stock in registration with the others. As discussed previously, each layer of the paper stock will also be provided with a recyclable glue or the like, to secure each layer of the paper stick to the other latters.

As will be appreciated, while FIG. 4 of the present invention illustrates four rolls of paper stock, 202, the present invention is not so limited in this regard. Indeed, the method and apparatus of the present invention equally contemplates a single-pass lamination process, involving three or more sheets, without departing from the broader spects of the present invention.

Returning now to FIG. 4, once the sheets from rolls 202 have been registered to one another in a planar fashion, the nacent lamination is then presented to a calendar device 204. As discussed previously, it is of the utmost importance that the eco-card construction enjoys a predetermined thickness and smoothness, and therefore the calendar device 204 is utilized as a caliper modulator in this regard. As will be further appreciated, the calendar device 204 is preferably, but not limited to, one or more pinch rollers capable of being manually or automatically adjusted so as to impart the proper and desired pressure to the nacent eco-card construction.

As further illustrated in FIG. 4, and subsequent to the nacent eco-card lamination being presented to the calendar device 204, the now-properly compressed and dimensioned eco-card lamination may be presented to a registration and deposition assembly 206.

The registration and deposition assembly 206 preferably employs sensors, optical detectors or other devices to properly register each eco-card platform for proper and accurately positioned printing and/or deposition.

Biodegradable ink is preferably utilized when printing is accomplished on the eco-card, and the deposition of holograms or other metallic designs or layers are accomplished by the registration and deposition assembly 206 on the order of one or more angstroms. Thus, even when printed, and even in the case of the inclusion of a metallic deposition or hologram, the eco-cards of the present invention are wholly reputable and recyclable, while still maintaining the rigidity and durability of known plastic cards and the like.

As also shown in FIG. 4, once the printing and/or deposition process is optionally completed via the assembly 206, if desired, the eco-card construction is then sheeted via a sheeting assembly 208. In a preferred embodiment, the sheeting assembly 208 is capable of cutting each individual eco-card from the continuous multi-layer lamination construct exiting the calendar device 204 and the deposition assembly 206. As will be appreciated, the cut or sheeted portions 210 of the laminate construction may then be stacked or otherwise prepared for transport or use.

Known lamination processes typically laminate no more than two roll stocks at one time. That is, in order to make a multi-layered laminate of three or more layers, known processes utilize a lamination of two sheets of stock together, and roll this two-ply lamination onto a first roll. Thereafter, this two-ply roll is then unrolled and laminated to another layer of stock, and so on. This known process, however, suffers from inherent deficiencies. As is known, every time a laminate of paper stock is rolled, for transport or for later use for laminations/printing thereon, the rolling of the laminate creates internal stresses to the material of the paper stock making up the laminate. Such damage is typically referred to as ‘roll setting’ and is undesirable. Thus, the greater the number of laminations, the greater the internal damage done to the laminate construction as a whole, as it rolled and unrolled during the manufacturing process.

The present eco-card manufacturing system 200 avoids the roll setting drawbacks of known laminate manufacturing processes, by enabling the lamination of three or more individual sheets of stock to one another, in a single, planar lamination process. Moreover, once so laminated, the three or more sheets of stock are registered, printed upon and/or enjoy metallic/holographic deposition, the finished eco-card laminate is then sheeted immediately while in a planar orientation, and without ever requiring the rolling of the laminate construction.

Thus, the proposed eco-card manufacturing system is not only quicker and more efficient than known multi-step lamination processes, but also avoids the internal stresses and loss of structural integrity that is inherent in known laminate constructions processes.

It should be noted that while the present eco-card lamination assembly 200 has been described in connection with making a paper stock card that includes no PVC/plastic, and which are entirely recyclable and repulpable, the present invention is not so limited in this regard. Indeed, the lamination assembly 200 could also be employed to manufacture laminations of three or more sheets of stock at the same time, whether the constituent elements of such a laminate were environmentally friendly and recyclable, or not, without departing from the broader aspects of the present invention.

Although this invention has been shown and described with respect to the detailed embodiments thereof, it will be understood by those of skill in the art that various changes may be made and equivalents may be substituted for elements thereof without departing from the scope of the invention. In addition, modifications may be made to adapt a particular situation or material to the teachings of the invention without departing from the essential scope thereof. Therefore, it is intended that the invention not be limited to the particular embodiments disclosed in the above detailed description, but that the invention will include all embodiments falling within the scope of this disclosure.

What is claimed is:

1. A manufacturing assembly for the creation of laminate constructions, said manufacturing assembly comprising:
a calendar device arranged to accept a laminate of three or more layers of material stock, said three or more layers of material stock being provided by a matching three or more rolls of said material stock;
a sheeting device arranged downstream from said calendar device, said sheeting device cutting said laminate into predetermined sizes; and
wherein said laminate is kept in a, non-rolled, planar orientation subsequent to said laminate exiting said calendar and before said laminate is sheeted by said sheeting device.

2. The manufacturing assembly for the creation of laminate constructions according to claim 1, said manufacturing assembly further comprising:
a registration and deposition assembly located downstream from said calendar device, said registration and deposition assembly determining a proper position for a deposition of substances on said laminate construction.

3. The manufacturing assembly for the creation of laminate constructions according to claim 2, wherein:
said substances include one of an ink and a metallic deposition.

4. A method for laminating three or more layers of a material stock in a single lamination process, said method comprising the steps of:
arranging three or more rolls of said material stock such that a layer of said material stock from each of said rolls is aligned with one another, to form thereby a nacent laminate;
passing said nacent laminate through a calendar device, said calendar device ensuring an appropriate thickness and smoothness to said nacent laminate and producing thereby a laminate construction; and
arranging a sheeting device downstream of said calendar device to cut said laminate construction into predetermined sizes, wherein said sheeting device is arranged in-line with said calendar device, and said laminate construction is maintained in a non-rolled condition prior to being provided to said sheeting device.

5. The method for laminating three or more layers of a material stock in a single lamination process according to claim 4, said method further comprising the steps of:
depositing a fixing agent between each of said layers, prior to presenting said nacent lamination to said calendar device.

6. The method for laminating three or more layers of a material stock in a single lamination process according to claim 4, said method further comprising the steps of:
passing said laminate construction through a registration and deposition assembly downstream of said calendar device, said registration and deposition assembly determining a proper position for the disposition of substances on said laminate construction.

7. The method for laminating three or more layers of a material stock in a single lamination process according to claim 6, said method further comprising the steps of:
forming said substances to be one of an ink or a metallic deposition.
